(19) United States
(12) Patent Application Publication
(10) Pub. No.: US 2007/0205966 A1
(43) Pub. Date: Sep. 6, 2007

(54) PLASMA DISPLAY APPARATUS AND DRIVING METHOD THEREOF

(75) Inventors: Kyung Woo Choi, Haeundae-gu (KR); Yu Hwan Park, Jinjoo-si (KR)

Correspondence Address: FISH & RICHARDSON P.C., P.O. BOX 1022, MINNEAPOLIS, MN, 55440-1022, US

(73) Assignee: LG Electronics, Youngdungpo-gu (KR)

(21) Appl. No.: 11/275,450

(22) Filed: Jan. 4, 2006

(30) Foreign Application Priority Data
Jan. 6, 2005 (KR) 10-2005-0001413

(51) Int. Cl. G09G 3/28

(52) U.S. Cl. 345/67

(57) ABSTRACT

A plasma display apparatus and a driving method thereof are provided. The plasma display apparatus comprises a plasma display panel including a scan electrode and a sustain electrode, a scan driver for applying a first pulse, which rises to a first voltage at a predetermined slope, to the scan electrode during a reset period, and a sustain driver for applying a second pulse to the sustain electrode during the reset period for applying the first pulse to the scan electrode.

This Nonprovisional application claims priority under 35 U.S.C. § 119(a) on Patent Application No. 10-2005-0001413 filed in Korea on Jan. 6, 2005, the entire contents of which are hereby incorporated by reference.

### BACKGROUND OF THE INVENTION

1. Field of the Invention

This document relates to a display apparatus, and more particularly, to a plasma display apparatus and a driving method thereof.

2. Description of the Background Art

A plasma display apparatus among various kinds of display apparatuses generally includes a plasma display panel and a driver for driving the plasma display panel.

Barrier ribs are formed between a front glass substrate and a rear glass substrate of the plasma display panel to form one unit cell. Each of cells is filled with a main discharge gas such as neon (Ne), helium (He) or a Ne-He gas mixture and an inert gas containing a small amount of xenon (Xe). When the plasma display panel is discharged by a high frequency voltage, the inert gas generates vacuum ultraviolet rays and phosphors formed between the barrier ribs are emitted by vacuum ultraviolet rays. By the processes, an image is implemented.

FIG. 1 shows a structure of a related art plasma display panel.

As shown in FIG. 1, the plasma display panel includes a front glass substrate 100 and a rear glass substrate 110 which are disposed in parallel to face each other at a given distance. A plurality of sustain electrode pairs, in which a plurality of scan electrodes 102 and a plurality of sustain electrodes 103 are formed in pairs, are arranged on a front glass 101 of the front glass substrate 100 that is a display surface for displaying images. A plurality of address electrodes 113 are arranged on a rear glass 111 of the rear glass substrate 110 to intersect the plurality of sustain electrode pairs.

The front glass substrate 100 includes the scan electrode 102 and the sustain electrode 103, which are discharged by each other in one discharge cell and sustain the light-emission of the cell. The scan electrode 102 and the sustain electrode 103 each include transparent electrodes 102a and 103a made of a transparent material and bus electrodes 102b and 103b made of a metal material such as Ag and make in pairs to form the sustain electrode pairs. The scan electrode 102 and the sustain electrode 103 limit a discharge current and are covered with one or more upper dielectric layers 104 to insulate between the sustain electrode pairs. A protective layer 105 formed by evaporating MgO is formed on upper surfaces of the dielectric layers 104 to facilitate discharge conditions.

A stripe type (or well type) of barrier ribs 112 are arranged in parallel in the rear glass substrate 110 to form a plurality of discharge spaces, that is, a plurality of discharge cells. Further, the plurality of address electrodes 113 which perform an address discharge to generate vacuum ultraviolet rays are disposed in parallel to the barrier bibs 112. Red (R), green (G) and blue (B) phosphors 114 which emit visible light for the image display during the address discharge are coated on an upper surface of the rear glass substrate 110. A lower dielectric layer 115 for protecting the address electrodes 113 is formed between the address electrodes 113 and the phosphors 114.

A method of achieving gray scales in a plasma display panel is shown in FIG. 2.

FIG. 2 shows a method of achieving gray scales in a related art plasma display panel.

As shown in FIG. 2, in the plasma display panel, one frame is divided into several subfields whose number of light-emissions are different from one another. Each of the subfields includes a reset period for initializing all cells, an address period for selecting a cell to be discharged and a sustain period for realizing gray scale according to the number of times the discharges are performed. For example, in a case of realizing 256 level gray scale, a frame period (16.67 ms) corresponding to 1/60 sec, as shown in FIG. 2 is divided into eight subfields SF1 to SF8. The eight subfields SF1 to SF8 each includes a reset period, an address period and a sustain period.

The duration of the reset period is the same as the duration of the address period for each of the subfields. The voltage difference between an address electrode and a transparent electrode which is a scan electrode generates an address discharge for selecting the cells to be discharged. The sustain period increases in a ratio of 2ⁿ (n=0, 1, 2, 3, 4, 5, 6, 7) at each of the subfields. As described above, since the sustain period changes according to weight values of the subfields, a gray scale is realized by adjusting the sustain period of each of the subfields, that is, the number of times the sustain discharges are performed. A driving waveform according to a driving method of the plasma display panel is shown in FIG. 3.

FIG. 3 shows a driving waveform according to a driving method of the related art plasma display panel.

As shown in FIG. 3, the plasma display panel is driven by dividing into the reset period for initializing all the cells, the address period for selecting cells to be discharged, the sustain period for sustaining discharges of the selected cells and an erase period for erasing wall charges within the discharged cells.

In the reset period, a rising waveform RUp is simultaneously applied to all of the scan electrodes during a setup period. A weak dark discharge is generated within the discharge cells of the entire screen by the rising waveform RUp. By performing the setup discharge, positive wall charges are accumulated on the address electrode and the sustain electrode and negative wall charges are accumulated on the scan electrode.

In a setdown period, after the rising waveform RUp is supplied during the setup period, a falling waveform RDp which falls from a positive voltage lower than a peak voltage of the rising waveform RUp to a specific voltage of a ground level voltage or less is supplied to the cells to generate a weak erasure discharge within the cells. The weak erase discharge sufficiently erases the wall charges excessively accumulated on the scan electrode. By performing the setdown discharge, the wall charges uniformly remain within the cells to the degree that there is the generation of a stable address discharge.

In the address period, a negative scan pulse Sp is sequentially applied to the scan electrode and, at the same time, a positive data pulse Dp synchronized with the scan pulse Sp is applied to the address electrode. While the voltage difference between the negative scan pulse Sp and the positive data pulse Dp is added to the wall charges produced during the reset period, the address discharge is generated within the discharge cells to which the data pulse Dp is applied. The wall charges necessary for a discharge when applying a sustain voltage Vs are formed within the cells selected by the address discharge. A positive voltage Vz is supplied to the sustain electrode during the setdown period and the address period to decrease the voltage difference between the sustain electrode and the scan electrode, thereby preventing the discharge between the sustain electrode and the scan electrode from being generated.

In the sustain period, a sustain pulse SUSp is alternately supplied to the scan electrode and the sustain electrode. While the wall voltage within the cells selected by the address discharge is added to the sustain pulse SUSp, a sustain discharge, that is, a display discharge, is generated between the scan electrode and the sustain electrode whenever the sustain pulse SUSp is applied.

The driving of one subfield of the plasma display panel is completed by the above-described processes.

In the related art driving method of the plasma display panel as described above, a high voltage of about 400 V or more is supplied as a setup voltage during the setup period to achieve uniformly the wall charges within the discharged cells.

The supplying of high voltage to the plasma display panel can break down an insulating characteristic of the dielectric layer of the plasma display panel.

Further, the driving elements of the plasma display panel can be overload by the high voltage so that the driving elements of the plasma display apparatus must have a high-level withstanding voltage characteristic. This increases manufacturing costs of the plasma display apparatus. Further, there is a problem in that the driving efficiency of the plasma display apparatus is reduced.

### SUMMARY OF THE INVENTION

Accordingly, an object of the present invention is to solve at least the problems and disadvantages of the background art.

The present invention provides a plasma display apparatus and a driving method thereof, which can lower a driving voltage when the plasma display apparatus is driven.

According to an aspect of the present invention, there is provided a plasma display apparatus comprising a plasma display panel including a scan electrode and a sustain electrode, a scan driver for applying a first pulse, which rises to a first voltage at a predetermined slope, to the scan electrode during a reset period, and a sustain driver for applying a second pulse to the sustain electrode during the reset period for applying the first pulse to the scan electrode.

According to another aspect of the present invention, there is provided a method of driving a plasma display apparatus comprising applying a first pulse, which rises from a ground level voltage to a first voltage at a predetermined slope, to a scan electrode during a reset period, and applying a second pulse having the opposite polarity of the polarity of the first pulse to a sustain electrode during the reset period for applying the first pulse to the scan electrode.

According to still another aspect of the present invention, there is provided a method of driving a plasma display apparatus comprising applying a first pulse, which rises to a first voltage at a predetermined slope, to a scan electrode during a reset period, and applying a second pulse, which falls at a predetermined slope, to a sustain electrode during the application of the first pulse to the scan electrode.

The plasma display apparatus according to the present invention can be driven at a low voltage.

Further, since driving elements of the plasma display apparatus according to the present invention do not need to have a high-level withstanding voltage characteristic capable of withstanding a high voltage, manufacturing costs decrease.

### BRIEF DESCRIPTION OF THE DRAWINGS

The accompany drawings, which are included to provide a further understanding of the invention and are incorporated in and constitute a part of this specification, illustrate embodiments of the invention and together with the description serve to explain the principles of the invention. In the drawings:

FIG. 1 shows a structure of a related art plasma display panel;

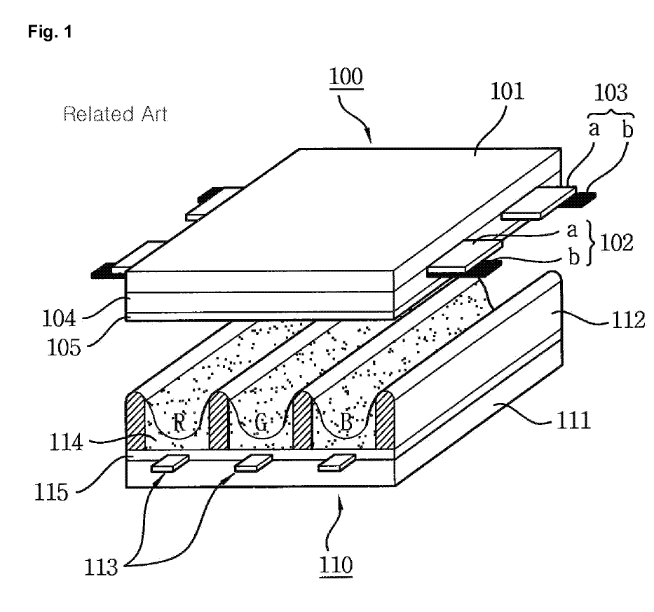

FIG. 2 shows a method of achieving gray scales in the related art plasma display panel;

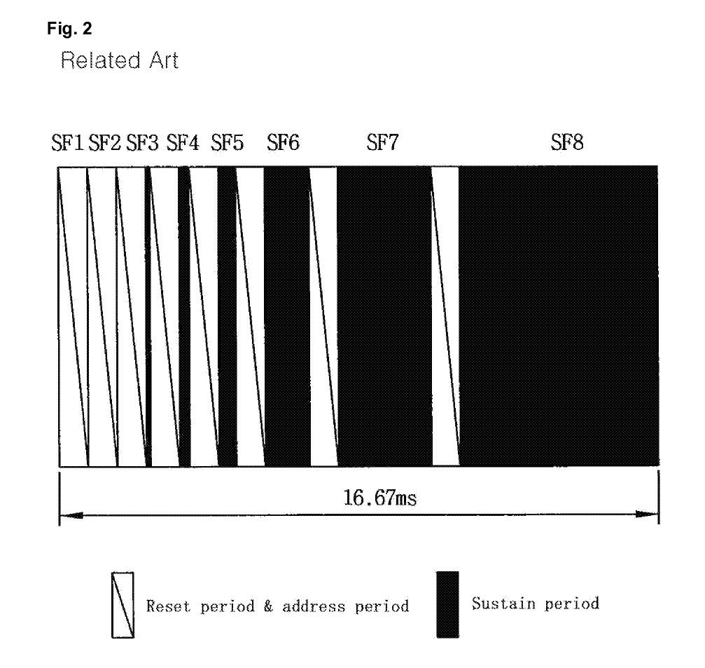

FIG. 3 shows a driving waveform according to a driving method of the related art plasma display panel;

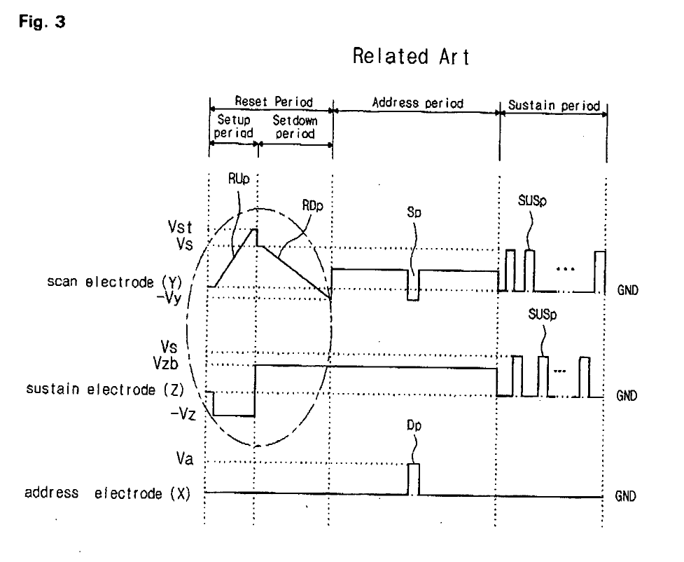

FIG. 4 shows a plasma display apparatus according to embodiments of the present invention;

FIG. 5 illustrates a driving method of a plasma display apparatus according to a first embodiment of the present invention;

FIG. 6 illustrates a driving method of a plasma display apparatus according to a second embodiment of the present invention; and

FIG. 7 illustrates a driving method of a plasma display apparatus according to a third embodiment of the present invention.

### DETAILED DESCRIPTION OF PREFERRED EMBODIMENTS

Reference will now be made in detail to embodiments of the present invention, examples of which are illustrated in the accompanying drawings.

A plasma display apparatus according to the present invention comprises a plasma display panel including a scan electrode and a sustain electrode, a scan driver for applying a first pulse, which rises to a first voltage at a predetermined slope, to the scan electrode during a reset period, and a sustain driver for applying a second pulse to the sustain electrode during the reset period for applying the first pulse to the scan electrode.

A voltage of the first pulse remains at the first voltage for a predetermined duration of time.

The polarity of the first pulse is different from the polarity of the second pulse.

The polarity of the first pulse is positive.

The magnitude of the second pulse is less than the magnitude of the first pulse.

An absolute value of a voltage of the second pulse is the same as a DC voltage supplied to the sustain electrode during an address period.

An application time point of the second pulse is substantially the same as an application time point of the first pulse.

The application time point of the second pulse is different from the application time point of the first pulse.

The second pulse is a sloped pulse.

The second pulse is a square wave.

A method of driving a plasma display apparatus according to the present invention comprises applying a first pulse, which rises from a ground level voltage to a first voltage at a predetermined slope, to a scan electrode during a reset period, and applying a second pulse having the opposite polarity of the polarity of the first pulse to a sustain electrode during the reset period for applying the first pulse to the scan electrode.

The second pulse is a square wave.

A method of driving a plasma display apparatus according to the present invention comprises applying a first pulse, which rises to a first voltage at a predetermined slope, to a scan electrode during a reset period, and applying a second pulse, which falls at a predetermined slope, to a sustain electrode during the application of the first pulse to the scan electrode.

Hereinafter, exemplary embodiments of the present invention will be described in detail with reference to the attached drawings.

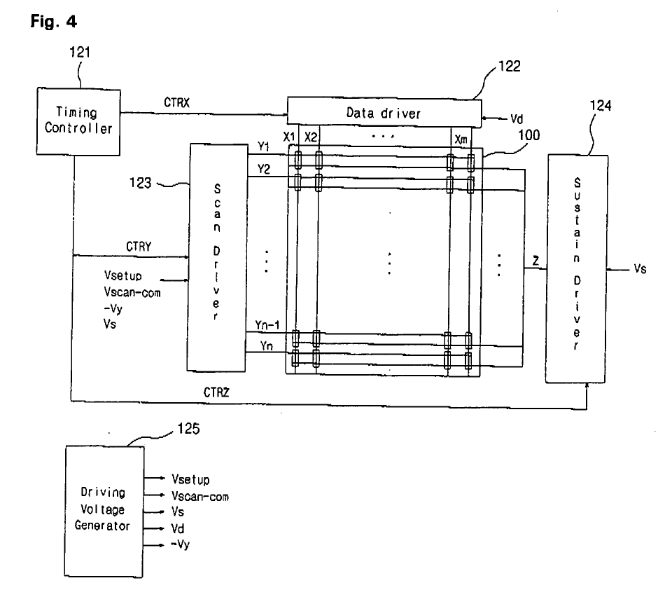

FIG. 4 shows a plasma display apparatus according to embodiments of the present invention.

As shown in FIG. 4, a plasma display apparatus according to embodiments of the present invention includes a plasma display panel 100, a data driver 122 for supplying data to address electrodes X1 to Xm formed on a lower substrate (not shown) of the plasma display panel 100, a scan driver 123 for driving scan electrodes Y1 to Yn, a sustain driver 124 for driving sustain electrodes Z being common electrodes, a timing controller 121 for controlling the data driver 122, the scan driver 123, the sustain driver 124 when the plasma display panel is driven, and a driving voltage generator 125 for supplying a necessary driving voltage to each of the drivers 122, 123 and 124.

An upper substrate (not shown) and the lower substrate of the plasma display panel 100 are joined with each other at a given distance. On the upper substrate, a plurality of electrodes, for example, the scan electrodes Y1 to Yn and the sustain electrodes Z are formed in pairs. On the lower substrate, the address electrodes X1 to Xm are formed to intersect the scan electrodes Y1 to Yn and the sustain electrodes Z.

The data driver 122 receives data, which is inverse-gamma corrected and error diffused in an inverse gamma correction circuit (not shown) and an error diffusion circuit (not shown) and then mapped to each of the subfields in a subfield mapping circuit (not shown). In the data driver 122, the data is sampled and latched in response to a timing control signal CTRX from the timing controller 121 and then is supplied to the address electrodes X1 to Xm.

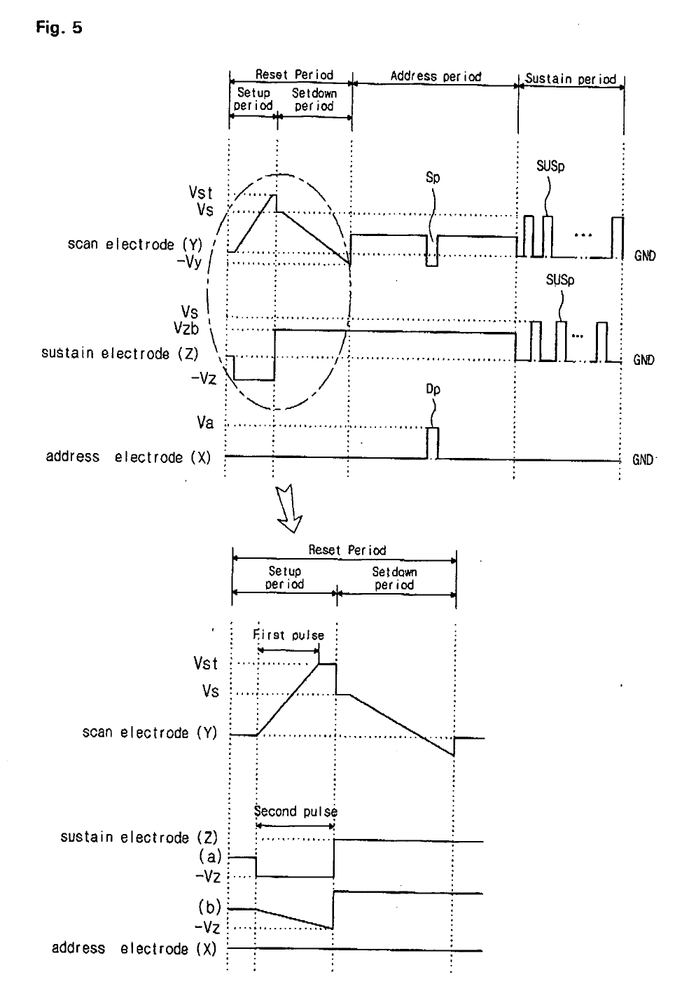

Under the control of the timing controller 121, the scan driver 123 supplies a first pulse, which rises to a first voltage Vst (refer to FIG. 5) at a predetermined slope, to the scan electrode during reset periods of one or more subfields of a plurality of subfields. The voltage of the scan electrode remains at the first voltage Vst for a predetermined duration of time and then perpendicularly falls to a second voltage Vs that is less than the first voltage Vst. Afterwards, a falling pulse, which falls at a predetermined slope, is supplied to the scan electrode.

The reason why the voltage of the scan electrode remains at the first voltage Vst for the predetermined duration of time is to uniform wall charges of the scan electrode. Only, the predetermined duration of time can be omitted to ensure a margin of driving timing.

Under the control of the timing controller 121, the scan driver 123 sequentially supplies a scan pulse of a scan voltage-Vy to the scan electrodes Y1 to Yn during an address period. The scan driver 123 supplies a sustain pulse, which is generated by an energy recovery circuit (not shown) installed in the scan driver 123, to the scan electrodes Y1 to Yn during a sustain period.

Under the control of the timing controller 121, the sustain driver 124 supplies a second pulse, which falls at a predetermined slope, or a square wave to the sustain electrodes Z during the reset periods of one or more subfields of the plurality of subfields, more specifically, during the supply of the first pulse to the scan electrode by the scan driver 123. The sustain driver 124 supplies a predetermined bias voltage Vzb (refer to FIG. 5) to the sustain electrodes Z during the address period. During the sustain period, an energy recovery circuit (not shown) installed in the sustain driver 124 and the energy recovery circuit (not shown) installed in the scan driver 123 are operated alternately to supply the sustain pulse to the sustain electrodes Z.

The timing controller 121 receives a vertical/horizontal synchronization signal and a clock signal and generates timing control signals CTRX, CTRY and CTRZ for controlling operation timing and synchronization of each of the drivers 122, 123 and 124 in the reset period, the address period and the sustain period. The timing controller 121 supplies the timing control signals CTRX, CTRY and CTRZ to the corresponding drivers 122,123 and 124 to control each of the drivers 122,123 and 124.

The data control signal CTRX includes a sampling clock for sampling data, a latch control signal, and a switch control signal for controlling an on/off time of a sustain driving circuit and a driving switch element. The scan control signal CTRY includes a switch control signal for controlling an on/off time of a sustain driving circuit and a driving switch element, which are installed in the scan driver 123. The sustain control signal CTRZ includes a switch control signal for controlling on/off time of a sustain driving circuit and a driving switch element, which are installed in the sustain driver 124.

The driving voltage generator 125 generates a setup voltage Vsetup, a scan common voltage Vscan-com, a scan voltage-Vy, a sustain voltage Vs, and a data voltage Vd. The driving voltages can be varied depending on a composition of a discharge gas or a structure of the discharge cells.

FIG. 5 illustrates a driving method of a plasma display apparatus according to a first embodiment of the present invention.

As shown in FIG. 5, the plasma display apparatus of the first embodiment of the present invention is driven by dividing into a reset period for initializing all cells of a plasma display panel, an address period for selecting cells to be discharged and a sustain period for sustaining discharges of the selected cells.

In the reset period, a first pulse rising to a first voltage Vst is simultaneously applied to all of the scan electrodes during a setup period. The first pulse is a positive pulse and a weak discharge is generated within all discharge cells of the plasma display panel by the first pulse. Due to the weak discharge, positive wall charges are accumulated on an address electrode X and a sustain electrode Z, negative wall charges are accumulated on a scan electrode Y.

During the setup period, a reset voltage including a setup voltage, which rises from a ground level voltage GND to the first voltage Vst at a predetermined slope, remains at the first voltage Vst for a predetermined duration of time and then perpendicularly falls to a second voltage Vs that is than the first voltage Vst, is applied to all the scan electrodes. A second pulse of the polarity different from the polarity of the first pulse applied to the scan electrodes is applied to the sustain electrodes. The second pulse, as shown by (a) and (b) in FIG. 5, is a square pulse or a falling pulse. The magnitude of a voltage of the second pulse is less than the magnitude of the voltage of the first pulse.

An absolute value of the voltage of the second pulse is the same as the magnitude of a positive DC voltage supplied to the sustain electrode during the address period which will be described later.

An application time point of the second pulse applied to the sustain electrode is substantially the same as an application time point of the first pulse applied to the scan electrode.

Positive charges are accumulated on the sustain electrode by an electrostatic affinity due to an electric field formed by applying the negative square pulse voltage—Vz.

In a setdown period, a falling pulse is applied to the scan electrode and a positive DC voltage Vzb is supplied to the sustain electrode so that wall charges necessary for a stable address discharge during the address period uniformly remain within the cells.

In the address period, a positive data pulse Dp and a negative scan pulse Sp are applied to the address electrode and the scan electrode in synchronous with each other, respectively. While the voltage difference between the address electrode and the scan electrode is added to the wall voltage between the address electrode and the scan electrode caused by the wall charges formed during the reset period, the address discharge is generated.

As described above, a large amount of the positive wall charges are accumulated on the sustain electrode during the reset period for the next address discharge. As a result, a stabe address discharge can be generated during the address period without applying a high voltage to the scan electrode in the reset period. Further, a sufficient driving margin of the plasma display apparatus can be obtained by increasing the driving efficiency of the plasma display apparatus.

The positive voltage Vzb is supplied to the sustain electrode during the address period to decrease the voltage difference between the sustain electrode and the scan electrode during the setdown period and the address period, thereby preventing generation of the discharge between the sustain electrode and the scan electrode.

In the sustain period, a sustain pulse SUSp is alternately applied to the scan electrode and the sustain electrode. While the wall voltages within the cells selected by the address discharge are added to the sustain pulse SUSp, a sustain discharge, that is, a display discharge, is generated between the scan electrode and the sustain electrode whenever the sustain pulse SUSp is applied.

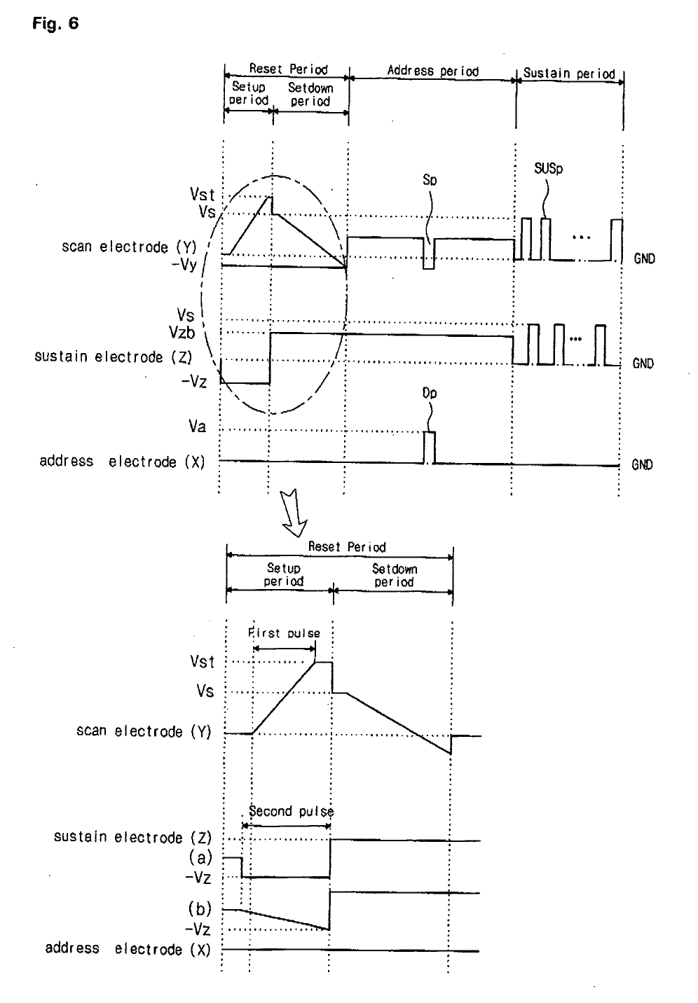

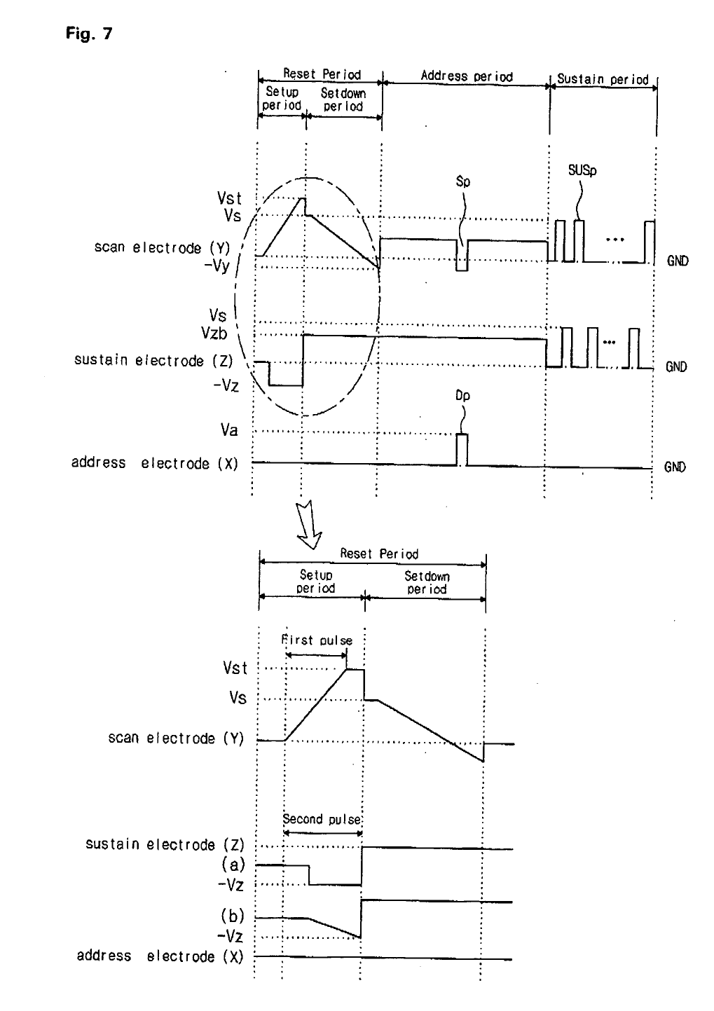

FIG. 6 illustrates a driving method of a plasma display apparatus according to a second embodiment of the present invention, and FIG. 7 illustrates a driving method of a plasma display apparatus according to a third embodiment of the present invention.

The driving method of the plasma display apparatus according to the second and third embodiments of the present invention shown in FIGS. 6 and 7 is almost the same as the driving method of the plasma display apparatus according to the first embodiment of the present invention shown in FIG. 5. Only, an application time point of a second pulse applied to a sustain electrode is different from an application time point of a first pulse applied to a scan electrode during a reset period.

As shown in FIG. 6, the application time point of the second pulse applied to the sustain electrode is earlier than the application time point of the first pulse applied to the scan electrode. An amount of time corresponding to the difference between the application time point of the second pulse and the application time point of the first pulse is less than ⅕ of the total amount of time of the setup period. If the amount of time is longer than ⅕, the potential difference between the scan electrode and the sustain electrode is not enough to generate a reset discharge during a reset period.

As shown in FIG. 7, contrary to FIG. 6, an application time point of the second pulse applied to the sustain electrode is later than an application time point of the first pulse applied to the scan electrode. An amount of time corresponding to the difference between the application time points of the second pulse and the first pulse is less than ⅕ of the total amount of time of the setup period. Since the reason is the same as that of the second embodiment, the description thereabout is omitted.

As described above, if the application time point of the first pulse applied to the scan electrode is different from the application time point of the second pulse applied to the sustain electrode in the reset period, a displacement current generated between the scan electrode and the sustain electrode, which are next to each other, decreases so that pulse noise will decrease.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A plasma display apparatus comprising:
a plasma display panel including a scan electrode and a sustain electrode;
a scan driver for applying a first pulse, which rises to a first voltage at a predetermined slope, to the scan electrode during a reset period; and
a sustain driver for applying a second pulse to the sustain electrode during the reset period for applying the first pulse to the scan electrode.

2. The plasma display apparatus as claimed in claim 1, wherein a voltage of the first pulse remains at the first voltage for a predetermined duration of time.

3. The plasma display apparatus as claimed in claim 1, wherein the polarity of the first pulse is different from the polarity of the second pulse.

4. The plasma display apparatus as claimed in claim 3, wherein the polarity of the first pulse is positive.

5. The plasma display apparatus as claimed in claim 1, wherein the magnitude of the second pulse is less than the magnitude of the first pulse.

6. The plasma display apparatus as claimed in claim 1, wherein an absolute value of a voltage of the second pulse is the same as a DC voltage supplied to the sustain electrode during an address period.

7. The plasma display apparatus as claimed in claim 1, wherein an application time point of the second pulse is substantially the same as an application time point of the first pulse.

8. The plasma display apparatus as claimed in claim 1, wherein the application time point of the second pulse is different from the application time point of the first pulse.

9. The plasma display apparatus as claimed in claim 1, wherein the second pulse is a sloped pulse.

10. The plasma display apparatus as claimed in claim 1, wherein the second pulse is a square wave.

11. A method of driving a plasma display apparatus comprising:
applying a first pulse, which rises from a ground level voltage to a first voltage at a predetermined slope, to a scan electrode during a reset period; and
applying a second pulse having the opposite polarity of the polarity of the first pulse to a sustain electrode during the reset period for applying the first pulse to the scan electrode.

12. The method as claimed in claim 11, wherein an application time point of the second pulse is substantially the same as an application time point of the first pulse.

13. The method as claimed in claim 11, wherein the application time point of the second pulse is different from the application time point of the first pulse.

14. The method as claimed in claim 11, wherein the second pulse is a square wave.

15. A method of driving a plasma display apparatus comprising:
applying a first pulse, which rises to a first voltage at a predetermined slope, to a scan electrode during a reset period; and
applying a second pulse, which falls at a predetermined slope, to a sustain electrode during the application of the first pulse to the scan electrode.

16. The method as claimed in claim 15, wherein a voltage of the first pulse remains at the first voltage during a predetermined duration of time.

17. The method as claimed in claim 15, wherein the polarity of the first pulse is different from the polarity of the second pulse.

18. The method as claimed in claim 15, wherein the magnitude of the second pulse is less than the magnitude of the first pulse.

19. The method as claimed in claim 15, wherein an application time point of the second pulse is substantially the same as an application time point of the first pulse.

20. The method as claimed in claim 15, wherein the application time point of the second pulse is different from the application time point of the first pulse.
